(19) United States
(12) Patent Application Publication
(10) Pub. No.: US 2008/0166597 A1
(43) Pub. Date: Jul. 10, 2008

(54) Magnetic Recording Medium, Production Process Thereof, and Magnetic Recording and Reproducing Apparatus

(75) Inventor: Hiroshi Osawa, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku (JP)

(21) Appl. No.: 11/884,661

(22) PCT Filed: Oct. 25, 2005
(86) PCT No.: PCT/JP05/19956

§ 371 Date: Aug. 20, 2007

Related U.S. Application Data
(60) Provisional application No. 60/658,145, filed on Mar. 4, 2005.

(30) Foreign Application Priority Data
Feb. 25, 2005 (JP) 2005-050878
Mar. 22, 2005 (JP) 2005-082053

(51) Int. Cl. G11B 5/33; G11B 5/62; G11B 5/84

(52) U.S. Cl. 428/812; 428/831; 427/131

(57) ABSTRACT

A magnetic recording medium is provided which is capable of higher recording density and has a higher coercive force and a lower noise. A production method of the magnetic recording medium, and a magnetic recording and reproducing apparatus are also provided. The magnetic recording medium comprises at least a nonmagnetic undercoat layer, a nonmagnetic intermediate layer, a magnetic layer, and a protective layer, which are laminated in this order on a nonmagnetic substrate, and at least one of the layers of the nonmagnetic undercoat layer is made of a WV alloy or a MoV alloy.

Priority is claimed to Japanese application No. 2005-050878, filed Feb. 25, 2005, and to Japanese application No. 2005-082053, filed Mar. 22, 2005, which are incorporated herein by reference. This application also claims the benefit pursuant to 35 U.S.C. §119(e)(1) of U.S. Provisional Applications, No. 60/658,145 filed on Mar. 4, 2005.

### TECHNICAL FIELD

The present invention relates to a magnetic recording medium used in hard disk drive and the like, a production method of the magnetic recording medium, and a magnetic recording and reproducing apparatus.

### BACKGROUND ART

Hard disk drive (HDD) which are one type of magnetic recording and reproducing apparatus, have currently reached a recording density of 100 Gbits/in², and it is said that the improvement in recording density will continue in the future at an annual rate of 30%. Consequently, the development of magnetic recording heads, and the development of magnetic recording mediums suitable for high recording density is being advanced. There is a need to increase the recording density of magnetic recording mediums used for hard disk drive, together with a demand for an improvement in coercive force, and a reduction in medium noise. For magnetic recording mediums used for hard disk drive, a structure where a metal film is laminated on a substrate for a magnetic recording medium by the sputtering method is mainstream. For a substrate used for a magnetic recording medium, aluminum substrates and glass substrates are widely used. An aluminum substrate is a mirror polished Al—Mg alloy with a Ni—P type alloy film formed on the substrate to a thickness of approximately 10 μm by electroless deposition, with a surface which is further mirror finished. For the two types of glass substrates, there are amorphous glass and crystallized glass. For either glass substrate, one which is mirror finished is used.

Currently, in magnetic recording mediums generally used in hard disk drive, a nonmagnetic undercoat layer (Cr, Cr type alloy or the like, Ni—Al type alloy), a nonmagnetic intermediate layer (Co—Cr, Co—Cr—Ta type alloy or the like), a magnetic layer (Co—Cr—Pt—Ta, Co—Cr—Pt—B type alloy or the like), and a protective layer (carbon or the like) are sequentially deposited on a nonmagnetic substrate, whereupon a lubricating layer comprising liquid lubricant is formed.

A Co—Cr—Pt—Ta alloy, Co—Cr—Pt—B alloy, and the like, used as the magnetic layer are alloys, which comprises Co as the principal component. The Co alloy takes a hexagonal close-packed structure (hcp structure) which has an axis of easy magnetization in its C-axis. For a recording method of the magnetic recording medium, there are in-plane recording and perpendicular recording, and a Co alloy is generally used for the magnetic film. In the case of in-plane recording, the C-axis of the Co alloy is oriented parallel to the nonmagnetic substrate, and in the case of a perpendicular medium, the C-axis of the Co alloy is oriented perpendicular to the nonmagnetic substrate. Accordingly, in the case of in-plane recording, it is preferable that the Co alloy is oriented in the (10•0) plane or the (11•0) plane.

To increase the recording density of magnetic recording mediums, it is necessary to decrease medium noise. Non-Patent Document 1 below describes a theoretical formula which indicates that it is effective to make the average crystalline particle diameter and the grain size distribution of the Co alloy smaller in order to decrease the medium noise. Non-Patent Document 2 below describes that by making the average crystalline particle diameter and the grain size distribution of the Co alloy smaller, the medium noise is decreased, and that a magnetic recording medium suitable for high recording density was provided. In such a manner, it is important for decreasing medium noise to reduce the average crystalline particle diameter and the grain size distribution of the Co alloy smaller. Since the Co alloy can be epitaxially grown on the Cr alloy, it can be easily considered that formation of Co alloy film contributes to reduce the average crystalline particle diameter and the grain size distribution of the Co alloy smaller.

It has been reported that addition of a variety of elements to Cr improves its properties. Patent Document 1 below describes that addition of Ti to Cr is effective. Patent Document 2 below describes that addition of V to Cr is effective. Patent Document 3 below reports that addition of Mo and W to Cr is effective. Patent Document 4 and Patent Document 5 below report that it is effective to construct an undercoat layer by two layers which have Cr as their principal component but a different additional element. In Patent Document 6 below, it is described that addition of oxygen and nitrogen to the nonmagnetic undercoat layer which has Cr as its principal component, is effective.

[Patent Document 1] Japanese Unexamined Patent Application, First Publication No. Sho 63-197018

[Patent Document 2] U.S. Pat. No. 4,652,499

[Patent Document 3] Japanese Unexamined Patent Application, First Publication No. Sho 63-187416

[Patent Document 4] Japanese Unexamined Patent Application, First Publication No. Hei 7-73427

[Patent Document 5] Japanese Unexamined Patent Application, First Publication No. 2000-322732

[Patent Document 6] Japanese Unexamined Patent Application, First Publication No. Hei 11-283235

[Patent Document 7] European Patent No. 0704839

[Patent Document 8] Japanese Unexamined Patent Application, First Publication No. 2003-123243

[Non-Patent Document 1] J. Appl. Phys. vol. 87, pp. 5365-5370

[Non-Patent Document 2] J. Appl. Phys. vol. 87, pp. 5407-5409

### DISCLOSURE OF THE INVENTION

As mentioned above, a Cr alloy is mainly used as the nonmagnetic undercoat layer. As a method of decreasing the medium noise by improving the nonmagnetic undercoat layer, micronization of the average crystalline particle diameter and improvement of orientation of the Cr alloy, and lattice matching with the Co alloy have been used. Since the Cr alloy used for the nonmagnetic undercoat layer has Cr as its principal component, the characteristics thereof mainly originate from the inherent characteristics of Cr. As a result, the scope for design of the nonmagnetic undercoat layer of the magnetic recording medium becomes consequently narrowed.

A number of attempts using a Cr alloy in the nonmagnetic undercoat layer have been proposed. In Patent Document 7, it has been proposed that the noise can be improved by using an alloy which has a B2 structure (AlNi, AlCo, AlFe, and the like) as the nonmagnetic undercoat layer, thus making the grain size in the magnetic film smaller. However, since it is difficult to make the coercive force large by use of an Al—Ni alloy, and it is difficult to make rectangularity ratio of the coercive force large by use of an Al—Co alloy, the reproduction output becomes smaller, as a result, leaving problems to realize a high recording density.

In Patent Document 8, it has been proposed that the noise can be improved by depositing Mo, W, or MoTi alloy, or WTi alloy on an oxide orientation control film such as MgO. However, elemental substance of Mo or W, or alloys such as MoTi and WTi have a limit to the decrease in noise, and are unable to cope with a recording density exceeding 50 Gbits/in².

The present invention has been carried out to solve the above-mentioned problems with an object of providing a magnetic recording medium which is able to cope with a higher recording density, a magnetic recording medium which has a higher coercive force and a lower noise, a production method thereof, and a magnetic recording and reproduction apparatus.

In order to solve the above problems, the present inventor, as a result of earnest investigation and effort, has completed the present invention by identifying that the characteristics of the magnetic recording and reproducing apparatus can be improved by utilizing a WV type alloy, or a MoV type alloy as the nonmagnetic undercoat layer. That is to say, the present invention relates to the following.

(1) A magnetic recording medium characterized in that at least a nonmagnetic undercoat layer, a nonmagnetic intermediate layer, a magnetic layer, and a protective layer are laminated in this order on a nonmagnetic substrate, and at least one layer of the nonmagnetic undercoat layer is configured by a WV type alloy or a MoV type alloy.

(2) A magnetic recording medium having at least a nonmagnetic undercoat layer, a stabilizing layer, a nonmagnetic intermediate layer, a magnetic layer, and a protective layer laminated in this order on a nonmagnetic substrate, and where the stabilizing layer is antiferromagnetically bonded to the magnetic layer, characterized in that at least one layer of the nonmagnetic undercoat layer is configured by a WV type alloy or a MoV type alloy.

(3) A magnetic recording medium according to (1) or (2), wherein the WV type alloy utilized in the nonmagnetic undercoat layer has a W content of 50 to 99 at %, and a V content of 1 to 50 at %.

(4) A magnetic recording medium according to (1) or (2), wherein the MoV type alloy utilized in the nonmagnetic undercoat layer has a Mo content of 50 to 99 at %, and a V content of 1 to 50 at %.

(5) A magnetic recording medium according to any one of (1) to (4), wherein the nonmagnetic intermediate layer comprises at least one element or alloy selected from the group consisting of a CoCr alloy, a CoCrPt alloy, Ru, a Ru alloy, Re, and a Re alloy.

(6) A magnetic recording medium according to any one of (1) to (4), wherein the non-magnetic coupling layer comprises at least one element or alloy selected from among Ru, Rh, Ir, Cr, Re, Ru alloy, Rh alloy, Ir alloy, Cr alloy, and Re alloy, and the non-magnetic coupling layer has a thickness of 0.5 to 1.5 μm.

(7) A magnetic recording medium according to any one of (1) to (4), wherein the nonmagnetic intermediate layer comprises at least one alloy selected from the group consisting of a CoCrZr alloy, a CoCrTa alloy, a CoRu alloy, a CoCrRu alloy, a CoCrPtZr alloy, a CoCrPtTa alloy, a CoPtRu alloy, and a CoCrPtRu alloy.

(8) A magnetic recording medium according to any one of (1) to (7), wherein the nonmagnetic undercoat layer is constituted by a multilayer structure including a layer comprising Cr or a Cr alloy comprising Cr and at least one element selected from the group of Ti, Mo, Al, Ta, W, Ni, B, Si, Mn and V, and a layer comprising a WV alloy or a MoV alloy.

(9) A magnetic recording medium according to any one of (1) to (8), wherein the magnetic layer comprises at least one alloy selected from the group consisting of a CoCrTa alloy, a CoCrPtTa alloy, a CoCrPtB alloy, and a CoCrPtBM (where M is one or more elements selected from Ta, Cu, and Ag) type alloy.

(10) A magnetic recording medium according to any one of (1) to (9), wherein the nonmagnetic substrate is either of a glass substrate and a silicon substrate.

(11) A magnetic recording medium according to any one of (1) to (9), wherein the nonmagnetic substrate has a film formed by NiP or a NiP alloy on one surface of a substrate which is selected from the group consisting of Al, Al alloy, glass, and silicon.

(12) A method of producing a magnetic recording medium having at least a nonmagnetic undercoat layer, a nonmagnetic intermediate layer, a magnetic layer, and a protective layer laminated in this order on a nonmagnetic substrate, wherein at least one layer of the nonmagnetic undercoat layer is provided by a WV type alloy or a MoV type alloy.

(13) A method of producing a magnetic recording medium having at least a nonmagnetic undercoat layer, a stabilizing layer, a non-magnetic coupling layer, a magnetic layer, and a protective layer laminated in this order on a nonmagnetic substrate, and where the stabilizing layer is antiferromagnetically bonded to the magnetic layer, wherein at least one layer of the nonmagnetic undercoat layer is provided by a WV type alloy or a MoV type alloy.

(14) A magnetic recording and reproduction apparatus comprising a magnetic recording medium according to any one of (1) to (13), and a magnetic head which records and reproduces information on the magnetic recording medium.

### BRIEF DESCRIPTION OF THE DRAWINGS

FIG. 1 is a cross-sectional view showing a first embodiment of a perpendicular magnetic recording medium of the present invention.

FIG. 2 is a cross-sectional view showing a second embodiment of a perpendicular magnetic recording medium of the present invention.

FIG. 3 is a block diagram showing one example of a magnetic recording and reproducing apparatus of the present invention.

### BRIEF DESCRIPTION OF THE REFERENCE SYMBOLS

1 Nonmagnetic substrate, 2 Nonmagnetic undercoat layer, 3 Nonmagnetic intermediate layer, 4 Magnetic layer, 5 Protective layer, 6 Lubricant layer, 7 Stabilizing layer, 8 Non-magnetic coupling layer, 10 Magnetic recording medium, 11 Magnetic recording medium, 12 Magnetic recording and reproducing apparatus, 13 Medium drive unit, 14 Magnetic head, 15 Head drive unit, 16 Record reproduction signal processing system

### BEST MODE FOR CARRYING OUT THE INVENTION

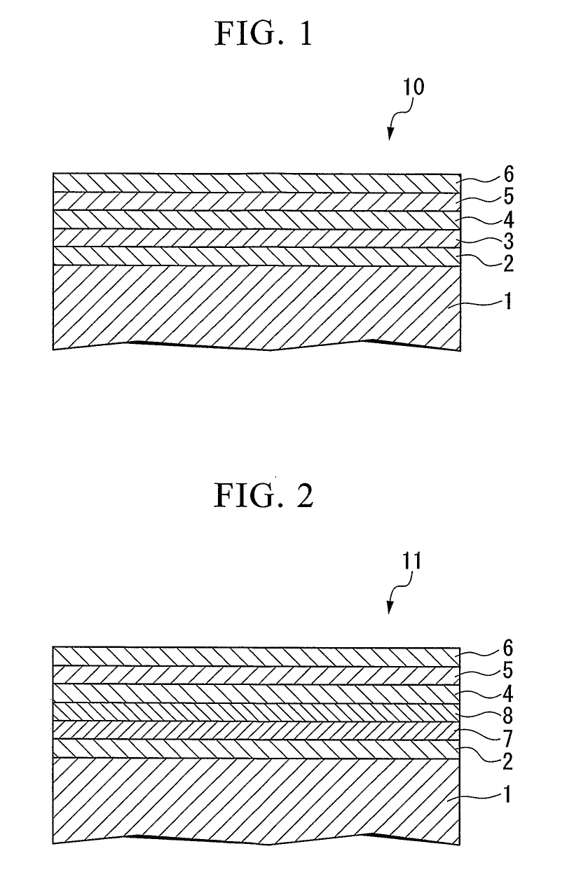

FIG. 1 shows a magnetic recording medium according to a first embodiment of the present invention. The magnetic recording medium 10 shown in FIG. 1 is one in which a nonmagnetic undercoat layer 2, a nonmagnetic intermediate layer 3, a magnetic layer 4, a protective layer 5, and a lubricant film 6 are sequentially laminated on a nonmagnetic substrate 1.

FIG. 2 shows a magnetic recording medium according to a second embodiment of the present invention. The magnetic recording medium 10 shown in FIG. 2 is one in which a nonmagnetic undercoat layer 2, a stabilizing layer 7, a non-magnetic coupling layer 8, a magnetic layer 4, protective layer 5, and a lubricant layer 6 are sequentially laminated on a nonmagnetic substrate 1. The film configuration shown in FIG. 2 is a technology designed to prevent thermal fluctuation of the magnetic layer. In a magnetic recording medium utilizing this technology, since magnetization directions of two magnetic layers are mutually inverted, the section participating in magnetic recording and magnetic reproduction substantially becomes thinner than the thickness of the whole recording film. Therefore, it is possible for the SNR to be improved. On the other hand, it is possible to improve the thermal instability, because total volume of crystal grains of the whole recording layer becomes large.

A medium utilizing this technology is generally called an AFC medium (Antiferromagnetically-Coupled Media), or an SFM (Synthetic Ferrimagnetic Media). Here, these will be generically called AFC mediums.

As the nonmagnetic substrate 1 in the present invention, a metallic substrate made of a metallic material such as Al, and Al alloy is used, on which a film made of NiP or NiP alloy formed is provided. As the nonmagnetic substrate 1, nonmetallic materials such as glass, ceramics, silicon, silicon carbide, carbon, and resin may be used, or one in which an NiP or NiP alloy film has been formed on a substrate made of nonmetallic material may be used. As the nonmetallic material, from the point of surface smoothness, one type selected from glass or silicon is desirable. In particular, from the point of cost and durability, it is desirable to use glass. As glass, crystallized glass or amorphous glass may be used. As amorphous glass, general purpose soda-lime glass, alumino-borosilicate glass, or alumino-silicate glass may be used. As a crystallized glass, lithium crystallized glass may be used. As a ceramic substrate, a sintered body or a fiber-reinforced material thereof of general purpose aluminum oxide, silicon nitride, and the like, as its principal component can be adopted. Since lowering of the flying height of the magnetic head is required to increase the recording density, it is preferable to increase the surface smoothness of the nonmagnetic substrate 1. That is to say, it is preferable for the surface average roughness Ra of the nonmagnetic substrate 1 to be not greater than 2 nm, and preferably not greater than 1 nm.

It is preferable to form texture marks by texture processing on the surface of the nonmagnetic substrate 1. In texture processing, it is desirable for the average roughness of the substrate surface to be made not less than 0.1 nm and not greater than 0.7 nm (more preferably not less than 0.1 nm and not greater than 0.5 nm, and still more preferably not less than 0.1 nm and not greater than 0.35 nm). From the point of strengthening the magnetic anisotropy in the circumferential direction of the magnetic recording medium, it is preferable for the texture marks to be formed approximately in the circumferential direction. It is preferable for the micro-waviness (Wa) of the surface nonmagnetic substrate 1 to be not greater than 0.3 nm (more preferably not greater than 0.25 nm). Furthermore, for the flight stability of the magnetic head, it is preferable to make the surface average roughness Ra of at least one of either the chamfered surface of chamfer portion of the end face or the side face, to be not greater than 10 nm (more preferably not greater than 9.5 nm). The micro-waviness (Wa) can, for example, be measured as a surface average roughness at a measuring range of 80 μm, by utilizing a surface roughness measuring apparatus P-12 (product of KLM-Tencor).

The nonmagnetic undercoat layer 2 is formed on the nonmagnetic substrate. A WV type alloy or a MoV type alloy is used in at least one layer of the nonmagnetic undercoat layer 2. In the WV type alloy utilized in the nonmagnetic undercoat layer of the present invention, the W content is 50 to 99 at %, and the V content is 1 to 50 at %. When the V content is less than 1 at %, no effect of V appears, and when the V content exceeds 50 at %, the particle diameter of the WV alloy film increases, thereby increasing noise, which is not desirable.

Addition of elements such as W, Mo, and V to Cr has an effect of expanding the lattice constant, and is conventionally widely performed for matching with Co alloys. However, in recent years, because of the increase in the lattice constants of Co alloys from the increased addition of Pt to Co alloys, and the use of Ru alloys which have a larger lattice constant than Co alloys, a need to further expand the lattice constants is emerging. Cr, W, Mo, and V all take the same bcc structure, and their lattice constants are 2.88 Å for Cr, 3.16 Å for W, 3.14 Å for Mo, and 3.02 Å for V. For optimal matching with a Co alloy and Ru alloy with a Pt content of 8 to 16 at %, Cr and V are too small, and W and Mo are too large. To resolve this problem, it is effective to adjust the lattice constant by addition of V to W and Mo, and it is possible to achieve an optimal matching.

To the WV type alloy or MoV alloy, which are utilized in the nonmagnetic undercoat layer 2 of the present invention, an element which has an auxiliary effect may be added. Examples of the additional elements are B, C, Al, Si, Cr, Mn, Cu, Zr, Nb, Ru, Hf, Ta, Re, and the like. It is desirable for the total content of the additional elements to be not greater than 20 at %. If the total content exceeds 20 at %, the effect of the above-mentioned orientation adjustment layer decreases. The lower limit of the total content is 0.1 at %. When the content is less than 0.1 at %, the effect of the additional element is lost. The effect of adding B and Al is especially large, and the utilization of a WVB alloy, a WVAl alloy, a WVAlB alloy, an MoVB alloy, an MoVAl alloy or an MoVAlB alloy greatly contributes to noise reduction.

In the present invention, when the nonmagnetic undercoat layer 2 is formed by not less than two layers, a WV type alloy or MoV type alloy is utilized for the layer on the nonmagnetic intermediate layer 3 side. However, for the other layers, a Cr layer, or a Cr alloy layer containing at least one type selected from the group consisting of Ti, Mo, Al, Ta, W, Ni, B, Si, Mn and V may be used.

In the present invention, it is desirable for the film thickness of the nonmagnetic undercoat layer 2 to form within a range of 10 Å to 300 Å. When the film thickness of the nonmagnetic undercoat layer 2 is less than 10 Å, the crystalline orientation of the nonmagnetic undercoat layer 2 is insufficient, lowering its coercive force. If the film thickness of the nonmagnetic undercoat layer 2 exceeds 300 Å, the magnetic anisotropy of the magnetic layer 4 in the circumferential direction decreases. It is more desirable to form a WV alloy film or MoV alloy film having a film thickness in the range of 5 Å to 100 Å. A Cr layer or a Cr alloy layer or the like having a film thickness in the range of 5 Å to 100 Å, is desirable for improving the coercive force and rectangularity of the magnetic layer 4. It is desirable for the crystalline orientation of the WV type alloy or the MoV type alloy of the nonmagnetic undercoat layer 2 to have the (100) plane as the preferred orientation plane. As a result, the crystalline orientation of the Co alloy of the magnetic layer 4 formed on the nonmagnetic undercoat layer 2 shows more strong (11•0) direction, and therefore improvements in the magnetic properties, for example coercive force (Hc), and improvements in record reproduction performance, for example SNR, can be obtained.

For the nonmagnetic intermediate layer 3 of the present invention, it is desirable to use a material to have a sufficiently good lattice matching hcp structure with, for example, the (100) plane of the nonmagnetic undercoat layer 2 therebeneath. For example, one comprising at least one material selected from a CoCr alloy, a CoCrPt alloy, Ru, an Ru type alloy, Re, or an Re alloy, is preferable. Still more desirable, utilizing an RuCr type alloy is effective in noise reduction. At this time, a Cr content of 1 to 50 at % is desirable. When the Cr content is less than 1 at %, the supplemental effect is not obtained, and when the Cr content exceeds 50 at %, the crystalline structure of the RuCr type alloy changes from the hcp structure to the bcc structure, causing a decrease in coercive force. It is desirable for the film thickness of the nonmagnetic intermediate layer 3 to be within the range of 10 Å to 100 Å. when the thickness of the nonmagnetic intermediate layer 3 is less than 10 Å, the crystalline orientation of the nonmagnetic undercoat layer 2 is insufficient, lowering its coercive force. If the nonmagnetic intermediate layer 3 film thickness exceeds 100 Å, the grains become large, causing an increase in noise.

For the magnetic layer 4 of the present invention, one alloy selected from a group consisting of a Co—Cr—Ta, a Co—Cr—Pt, a Co—Cr—Pt—Ta, a Co—Cr—Pt—B—Ta, a Co—Cr—Pt—B—Cu alloy, or a Co—Cr—Pt—B—Ag alloy, is desirable. For example, in the case of a Co—Cr—Pt alloy, from the point of SNR improvement, it is desirable to have a Cr content in the range of 10 at % to 27 at %, and a Pt content in the range of 8 at % to 16 at %. For example, in the case of a Co—Cr—Pt—B alloy, from the point of SNR improvement, it is desirable to have a Cr content in the range of 10 at % to 27 at %, a Pt content in the range of 8 at % to 16 at %, and a B content in the range of 1 at % to 20 at %. For example, in the case of a Co—Cr—Pt—B—Ta alloy, from the point of SNR improvement, it is desirable to have a Cr content in the range of 10 at % to 27 at %, a Pt content in the range of 8 at % to 16 at %, a B content in the range of 1 at % to 20 at %, and a Ta content in the range of 1 at % to 4 at %. For example, in the case of a Co—Cr—Pt—B—Cu type alloy, from the point of SNR improvement, it is desirable to have a Cr content in the range of 10 at % to 27 at %, a Pt content in the range of 8 at % to 16 at %, a B content in the range of 2 at % to 20 at %, and a Cu content in the range of 1 at % to 10 at %. For example, in the case of a Co—Cr—Pt—B—Ag type alloy, from the point of SNR improvement, it is desirable to have a Cr content in the range of 10 at % to 27 at %, a Pt content in the range of 8 at % to 16 at %, a B content in the range of 2 at % to 20 at %, and a Cu content in the range of 1 at % to 10 at %.

When the film thickness of the magnetic layer 4 is greater or equal to 10 nm, there is no problem from the viewpoint of thermal fluctuation, however, from the requirements of high recording density, less or equal to 40 nm is preferable. This is because if 40 nm is exceeded, the grain size of the magnetic layer 4 increases, and desirable record reproduction performance is unable to be obtained. The magnetic layer 4 may have a multilayered structure, and the material thereof may be selected from the above utilizing one of the combinations. In the case when the magnetic layer 4 is a multilayer structure, it is desirable from the point of record reproduction performance and SNR characteristic improvement, that the layer directly above the nonmagnetic intermediate layer 3, is a layer comprising a Co—Cr—Pt—B—Ta alloy, or a Co—Cr—Pt—B—Cu alloy, or a Co—Cr—Pt—B alloy. From the point of record reproduction performance and SNR characteristic improvement, it is desirable for the top layer to comprise a Co—Cr—Pt—B—Cu type alloy or a Co—Cr—Pt—B type alloy.

As the stabilizing layer 7 of the present invention, Co—Cr alloys, examples of desirable alloys includes a CoCrZr alloy, a CoCrTa alloy, a CoRu alloy, a CoCrRu alloy, a CoCrPtZr alloy, a CoCrPtTa alloy, a CoPtRu alloy, or a CoCrPtRu alloy. It is desirable for the film thickness of the stabilizing layer 7 to be within the range of 10 Å to 50 Å. When the stabilizing layer 7 film thickness is less than 10 Å, the stabilizing layer 7 no longer holds magnetization, and does not show antiferromagnetic binding with the magnetic layer 4, which is above the stabilizing layer with the non-magnetic coupling layer 8 placed therebetween. When the stabilizing layer 7 film thickness exceeds 50 Å, the grains become large, causing an increase in noise.

For the non-magnetic coupling layer 8 of the present invention, it is desirable that it includes one element or an alloy selected from Ru, Rh, Ir, Cr, Re, an Ru type alloy, an Rh type alloy, an Ir type alloy, a Cr type alloy, or an Re type alloy. In particular, it is more desirable to utilize Ru. If the film thickness of Ru is approximately 0.8 nm, the antiferromagnetic binding increases, which is desirable.

For the above-described protective layer 5, it is possible to use a conventionally known material, for example, simple substance such as carbon or SiC, or a material containing those as their principal components. When the protective layer is used in the case of a high density recording state, the film thickness of the protective layer 5 is desirably in the range of 1 nm to 10 nm from the point of decreasing the magnetic spacing and from the point of durability. Magnetic spacing represents the distance between the read/write element of the magnetic head, and the magnetic layer 4. The narrower the magnetic spacing becomes, the more the electromagnetic transfer characteristics improve. Since the protective layer 5 exists between the read/write element of the head, and the magnetic layer 4, this layer 5 becomes a factor in widening the magnetic spacing. A fluorine-containing lubricating layer 6 comprising, for example, a perfluoropolyether fluorine lubricant, may be provided on the protective film if necessary.

It is desirable for the magnetic layer 4 of the magnetic recording medium of the present invention to have a magnetization orientation layer (OR) of 1.05 or more (more preferably, 1.1 or more). The magnetization orientation layer is expressed by (coercive force in the circumferential direction/coercive force in the radial direction). If the magnetization orientation layer is not less than 1.05, an improvement in the magnetic characteristics, for example coercive force, and an improvement in the electromagnetic transfer characteristics, for example SNR, PW50, can be obtained. The magnetization orientation layer is defined as the ratio between the coercive force (Hc) in the circumferential direction and the Hc in the radial direction, however since the coercive force of the magnetic recording medium recently has becomes high, there are cases where the magnetization orientation layer is measured to be low.

In the present invention, in order to supplement this point, the magnetization orientation layer of the residual magnetization amount is used together. The magnetization orientation layer (MrtOR) of the residual magnetization amount is defined as the ratio between the residual magnetization amount (Mrt) in the circumferential direction and the residual magnetization amount (Mrt) in the radial direction (MrtOR=Mrt in the circumferential direction/Mrt in the radial direction). If the magnetization orientation layer of the residual magnetization amount is not less than 1.05, and more preferably not less than 1.1, an improvement in the magnetic characteristics, for example the coercive force, and an improvement in the electromagnetic transfer characteristics, for example SNR, PW50, can be obtained. The upper limit of the value of OR and MrtOR is ideally a situation where all of the magnetic domains of the magnetic film are directed in the circumferential direction, and in this situation the denominator of the magnetization orientation layer becomes zero, so that it becomes infinite. For the measurement of the magnetization orientation layer and magnetization orientation layer of the residual magnetization amount, a VSM (Vibrating Sample Magnetometer) is used.

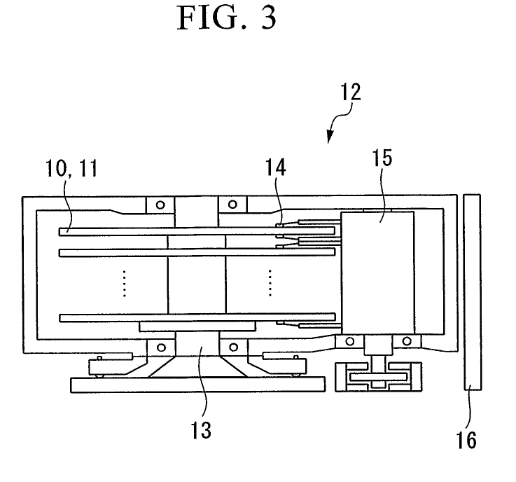

FIG. 3 shows an example of a magnetic recording and reproducing apparatus utilizing the above-mentioned magnetic recording medium.

The magnetic recording and reproducing apparatus 12 shown in FIG. 3 comprises a magnetic recording medium 10 constituted as shown in FIG. 1, or a magnetic recording medium 11 constituted as shown in FIG. 2, a medium drive unit 13 that rotates the magnetic recording medium 10, 11, a magnetic head 14 that records and reproduces the information in the magnetic recording medium 10, 11, a head drive unit 15 that relatively moves the magnetic head 14 with respect to the magnetic recording medium 10, 11, and a record reproduction signal processing system 16. The record reproduction signal processing system 16 is able to process the data input from the outside and send the record signal to the magnetic head 14, and process the reproduction signal from the magnetic head 14 and send the data to the outside. For the magnetic head 14 used in the magnetic recording and reproducing apparatus 12 of the present invention, not only an MR (magnetoresistance) element utilizing a giant magnetoresistance effect (GMR) as the reproduction element, but a magnetic head more suitable for high recording density which has a GMR element using a tunnel magnetoresistance (TMR) effect, and the like, may be used.

Furthermore, the magnetic recording and reproducing apparatus 12 of the present invention uses a magnetic recording medium 10, 11, which has a small average roughness and small micro-waviness. Therefore in addition to the improved electromagnetic transfer characteristics, the magnetic recording and reproducing apparatus is one with good error characteristics when the magnetic head is used at a low floating state in order to decrease spacing loss. According to the above-mentioned magnetic recording and reproducing apparatus 12, it becomes possible to manufacture a magnetic recording medium suitable for high recording density.

Next, an explanation is described regarding an example of a manufacturing method of the magnetic recording medium according to the present invention. For the nonmagnetic substrate 1, either of the materials indicated in (10), (11) mentioned above may be used. As one example, a situation where a substrate, in which a 12 μm NiP plating has been applied to an Al substrate (hereafter called a NiP plated Al substrate), is used.

Firstly, texture processing is applied to the surface of the NiP plated Al substrate, so as to form a texture marks of striations are formed to a line density of not less than 7500 (lines/mm) on the surface of the substrate. For example, a texture is applied in the circumferential direction by machine processing (also known as “mechanical texture processing”) using a fixed abrasive grain and/or a free abrasive grain to form texture marks of striations to a line density of not less than 7500 (lines/mm) on the surface of a glass substrate. For example, a grinding tape is pressed into contact with the surface of the substrate, and texture processing is performed by rotating both the substrate and the feeding of the grinding tape, while a grinding slurry containing the grinding abrasive grain is supplied between the substrate and the grinding tape, and.

Here, it is possible to make the rotation of the substrate in the range of 200 rpm to 1000 rpm. It is possible to make the feed rate of the grinding slurry in the range of 10 ml/min to 100 ml/min. It is possible to make the grinding tape feed speed in the range of 1.5 mm/min to 150 mm/min. It is possible to make the grain size of the abrasive grain contained in the abrasive slurry 0.05 μm to 0.3 μm at D90 (the grain size value when the cumulative mass % corresponds to 90 mass %). It is possible to make the pressing force of the tape 1 kgf to 15 kgf (9.8 N to 147 N (relative pressure)). In order to form the texture striations to a line density of not less than 7500 (lines/mm) (more preferably not less than 20000 (lines/mm)), it is desirable to set these conditions. It is desirable for the surface average roughness Ra of the NiP plated Al substrate with texture striations formed on its surface, to be in the range of 0.1 nm to 1 nm (1 Å to 10 Å), or preferably 0.2 nm to 0.8 nm (2 Å to 8 Å).

It is also possible to apply texture processing with additional oscillation. Oscillation is an operation where at the same time as the tape is being put in motion in the circumferential direction of the substrate, the tape is swung in the radial direction of the substrate. It is desirable for the oscillation condition to be 60 times/min to 1200 times/min. As a method of texture processing, it is possible to use a method where texture striations are formed to a line density of not less than 7500 (lines/mm). Other than the above-described mechanical texturing method, a method using a fixed abrasive grain, a method using a fixed whetstone, a method using laser processing, can be used. A measuring device such as an AFM (Atomic Force Microscope, product of Digital Instruments Co. (US)), for example, can be used for measuring the line density of the texture striations.

The measurement conditions of the line density are as follows. The scan width is 1 μm, the scan rate is 1 Hz, the number of samples is 256, and the mode is tapping mode. An AFM scan image is obtained by scanning the probe in the radial direction of the glass substrate which is the sample. A Flatten Order is set at the order of 2, and plane fit auto processing, which is a type of flattening processing, is carried out with respect to the X axis and Y axis of the scan image to perform the flattening correction on the image. With respect to a flatten corrected image, a box of approximately 0.5 μm×0.5 μm is set, and the line density within a region of the box is calculated. The line density is calculated by converting the total number of zero crossover points along both the X axis centerline and the Y axis centerline to a 1 mm scale. That is to say, the line density is the number of peaks and troughs of the texture striations in the radial direction on a 1 mm scale.

Each section in the sample plane is measured, and the average values and standard deviations of the measurement values thereof, are calculated. The average value is assigned as the line density of the striations of the glass substrate. The number of measurement points is determined by the number from which the average value and standard deviation is calculated. For example, the measurement number can be made to be 10 points. Furthermore, when the average value and standard deviation is calculated from 8 of these points, excluding the maximum value and the minimum value, abnormal measurement values can be excluded, and it is possible to improve the measurement accuracy.

After the NiP plated Al substrate has been washed, it is installed inside the chamber of a deposition chamber. The NiP plated Al substrate is heated to 100 to 400° C. as required. The nonmagnetic undercoat layer 2, the nonmagnetic intermediate layer 3, and the magnetic layer 4 are formed on the nonmagnetic substrate by a sputter method (for example a DC or RF magnetron sputtering method). The operating conditions for when the above-mentioned layers are formed by a sputter method, for example can be as follows.

The sputtering conditions for forming each film on the NiP plated Al substrate, for example, can be set as the following. The chamber interior used for deposition is evacuated until the vacuum level is in the range of 10⁻⁴ Pa to 10⁻⁷ Pa. Sputtering is performed by accommodating a glass substrate, on which surface a texture striations is formed, in the chamber interior, and discharging electricity by introducing an Ar gas as a sputter gas.

At this time, electric power is supplied within a range of 0.2 kW to 2.0 kW, and by adjusting the discharge time and supplied power, the desired film thickness can be obtained.

Hereunder, one example of a formation method of the magnetic recording medium is shown. The nonmagnetic undercoat layer of a thickness of 3 to 15 nm is formed by using a sputtering target comprising a WV alloy, a MoV alloy, Cr, a Cr alloy, or the like, on the nonmagnetic substrate.

Next, the nonmagnetic intermediate layer 3 of a thickness of 1 to 10 nm is formed by using a sputtering target comprising Ru or RuCr alloy. Next, the magnetic layer 4 of a thickness of 10 to 40 nm is formed by using a sputtering target comprising a CoCrTa alloy, a CoCrPt alloy, a CoCrPtTa alloy, a CoCrPtB alloy, a CoCrPtBTa alloy, a CoCrPtBCu alloy, a CoRuTa alloy, or the like. Next, the protective layer 5 of a thickness of 1 to 5 nm is formed by a conventionally known sputtering method or plasma CVD method. Next, if required, the lubricating layer 6 is formed by a conventionally known spin method or dip method. The above-mentioned magnetic recording medium is furnished with a nonmagnetic undercoat layer comprising a WV alloy or a MoV alloy. Therefore, the medium noise can be decreased.

FIG. 3 shows an example of a magnetic recording and reproducing apparatus using the above-mentioned magnetic recording medium. The magnetic recording and reproducing apparatus 12 shown in FIG. 3 is furnished with a magnetic recording medium 10 of the above-mentioned constitution, a medium drive unit 13 that rotates the magnetic recording medium 10, a magnetic head 14 that records and reproduces the information in the magnetic recording medium 10, a head drive unit 15 that relatively moves the magnetic head 14 with respect to the magnetic recording medium 10, and a record reproduction signal processing system 16. The record reproduction signal processing system 16 is able to process the data input from the outside and send the record signal to the magnetic head 14, and process the reproduction signal from the magnetic head 14 and send the data to the outside.

The magnetic head 14 used in the magnetic recording and reproducing apparatus 12 of the present invention possesses not only an MR (magnetoresistance) element utilizing a giant magnetoresistance effect (GMR) as the reproduction element, but also a magnetic head more suitable for high recording density which has a GMR element using a tunnel magnetoresistance (TMR) effect, and the like, may be used.

It becomes possible by using a TMR element to further increase the recording density.

Since the above-mentioned magnetic recording and reproducing apparatus 12 is provided with the magnetic recording medium 10 using a WV alloy or a MoV alloy in the nonmagnetic undercoat layer 2, medium noise can be decreased.

### EXAMPLES

Hereunder, specific examples are shown to clarify the operational effects of the present invention.

### Example 1

A nonmagnetic substrate 1 was used which has an NiP film (thickness 12 μm) formed by electroless deposition on the surface of a substrate made of Al (outside diameter 95 mm, inside diameter 25 mm, thickness 1.270 mm), and the surface average roughness Ra was made to be 0.5 nm by performing texture processing on the surface thereof. The nonmagnetic substrate 1 was accommodated in the chamber of a DC magnetron sputtering device (Anerva Corp., C3010), and after the chamber was evacuated to attain a vacuum level of 2×10⁻⁷ Torr (2.7×10⁻⁵ Pa), the nonmagnetic substrate 1 was heated to 250° C. A nonmagnetic undercoat layer 2 was provided on this substrate. The nonmagnetic undercoat layer 2 was prepared to have a multilayer structure, with a second undercoat layer (thickness 3 nm) comprising a WV alloy (W: 80 at %, V: 20 at %) on a first undercoat layer (thickness 2 nm) comprising Cr.

Subsequently, a nonmagnetic intermediate layer 3 (thickness 4 nm) comprising an RuCr alloy (Ru: 80 at %, Cr: 20 at %) was formed.

Subsequently, a magnetic layer 4 consisting of two magnetic layers was provided. A first magnetic layer (thickness 10 nm) comprising a CoCrPtB alloy (Co: 60 at %, Cr: 25 at %, Pt: 14 at %, B: 6 at %) was formed. Then, on top of the first layer, a second magnetic layer (thickness 10 nm) comprising a CoCrPtB alloy (Co: 60 at %, Cr: 10 at %, Pt: 15 at %, B: 15 at %) was formed.

When forming each of the above-mentioned layers, Ar was used as the sputter gas, and the pressure thereof was made to be 6 mTorr (0.8 Pa). Subsequently, a protective layer 5 (thickness 3 nm) comprising carbon was formed by CVD. Then, a lubricating layer 6 (thickness 2 nm) was formed by spreading a lubricant comprising perfluoropolyether on the surface of the protective layer 5, and the magnetic recording medium 10 was obtained.

Thereafter, a glide test was performed using a glide tester and a test condition is determined to be a glide height of 0.4 μinch. Samples, which have passed the glide test, were used for examining the record reproduction performance by means of a read/write analyzer RWA 1632 (product of GUZIK Co. (US)). For the record reproduction performance, electromagnetic transfer characteristics such as the reproduction signal output (TAA), the half-width (PW50) of the solitary wave reproduction output, the SNR, and the overwrite (OW) were measured. For evaluation of the record reproduction performance, a complex thin-film magnetic recording head, which had a giant magnetic resistance (GMR) element in its reproduction section, was used. The noise was measured as the integral noise from 1 MHz to 375 kFCI equivalent frequency when a 500 kFCI pattern signal was written. The reproduction output was measured at 250 kFCI, and was calculated as SNR=20×log(reproduction output/integral noise from 1 MHz to 375 kFCI equivalent frequency). For the measurement of the coercive force (Hc) and the rectangularity ratio (S*), an electro-optical Kerr effect type magnetic property measurement device (RO1900, product of Hitachi Electrical Engineering Co. (Japan)) was used. For the measurement of the magnetization orientation layer (OR) and the magnetization orientation layer of the residual magnetization amount (MrtOR), a VSM (BHV-35, product of Riken Electrical Co. (Japan)) was used.

### Examples 2 to 29

Apart from using an alloy of a composition and film thickness as shown in Table 1 instead of the composition and film thickness of the WV alloy, which is the second nonmagnetic undercoat layer 2, the magnetic recording medium was made in the same way as for Example 1.

In the table, 1 Oe is approximately 79 A/m.

TABLE 1

| | NONMAGNETIC UNDERCOAT LAYER | | | | | |
|---|---|---|---|---|---|---|
| | 1st UNDERCOAT | | 2nd UNDERCOAT | | NONMAGNETIC | |
| | LAYER | | LAYER | | INTERMEDIATE LAYER | |
| | | FILM | | FILM | | FILM |
| | ALLOY | THICKNESS | ALLOY | THICKNESS | ALLOY | THICKNESS |
| | COMPOSITION | (nm) | COMPOSITION | (nm) | COMPOSITION | (nm) |
| EXAMPLES 1 | Cr | 2 | 80W—20V | 3 | 80Ru—20Cr | 4 |
| EXAMPLES 2 | Cr | 2 | 80W—20V | 2 | 80Ru—20Cr | 4 |
| EXAMPLES 3 | Cr | 2 | 80W—20V | 5 | 80Ru—20Cr | 4 |
| EXAMPLES 4 | Cr | 2 | 90W—10V | 3 | 80Ru—20Cr | 4 |
| EXAMPLES 5 | Cr | 2 | 60W—40V | 3 | 80Ru—20Cr | 4 |
| EXAMPLES 6 | Cr | 2 | 70W—20V—10Al | 3 | 80Ru—20Cr | 4 |
| EXAMPLES 7 | Cr | 2 | 75W—20V—5B | 3 | 80Ru—20Cr | 4 |
| EXAMPLES 8 | Cr | 2 | 65W—20V—10Al—5B | 3 | 80Ru—20Cr | 4 |
| EXAMPLES 9 | Cr | 2 | 80Mo—20V | 3 | 80Ru—20Cr | 4 |
| EXAMPLES 10 | Cr | 2 | 90Mo—10V | 3 | 80Ru—20Cr | 4 |
| EXAMPLES 11 | Cr | 2 | 60Mo—40V | 3 | 80Ru—20Cr | 4 |
| EXAMPLES 12 | Cr | 2 | 70Mo—20V—10Al | 3 | 80Ru—20Cr | 4 |
| EXAMPLES 13 | Cr | 2 | 75Mo—20V—5B | 3 | 80Ru—20Cr | 4 |
| EXAMPLES 14 | Cr | 2 | 65Mo—20V—10Al—5B | 3 | 80Ru—20Cr | 4 |
| EXAMPLES 15 | Cr | 2 | 99W—1V | 3 | 80Ru—20Cr | 4 |
| EXAMPLES 16 | Cr | 2 | 95W—5V | 3 | 80Ru—20Cr | 4 |
| EXAMPLES 17 | Cr | 2 | 55W—45V | 3 | 80Ru—20Cr | 4 |
| EXAMPLES 18 | Cr | 2 | 50W—50V | 3 | 80Ru—20Cr | 4 |
| EXAMPLES 19 | Cr | 2 | 45W—55V | 3 | 80Ru—20Cr | 4 |
| EXAMPLES 20 | Cr | 2 | 99Mo—1V | 3 | 80Ru—20Cr | 4 |
| EXAMPLES 21 | Cr | 2 | 95Mo—5V | 3 | 80Ru—20Cr | 4 |
| EXAMPLES 22 | Cr | 2 | 55Mo—45V | 3 | 80Ru—20Cr | 4 |
| EXAMPLES 23 | Cr | 2 | 50Mo—50V | 3 | 80Ru—20Cr | 4 |
| EXAMPLES 24 | Cr | 2 | 45Mo—55V | 3 | 80Ru—20Cr | 4 |
| EXAMPLES 25 | Cr | 2 | 80W—20V | 3 | Ru | 4 |
| EXAMPLES 26 | Cr | 2 | 80W—20V | 3 | 90Ru—10Cr | 4 |
| EXAMPLES 27 | Cr | 2 | 80W—20V | 3 | 70Ru—30Cr | 4 |
| EXAMPLES 28 | Cr | 2 | 80W—20V | 3 | 60Ru—40Cr | 4 |
| EXAMPLES 29 | Cr | 2 | 80W—20V | 3 | 50Ru—50Cr | 4 |

| | COERCIVE | | | | | | | |
|---|---|---|---|---|---|---|---|---|
| | FORCE | ANGULARITY | | | TAA | OW | PW50 | SNR |
| | (Oe) | RATIO | OR | MrtOR | (μV) | (dB) | (ns) | (dB) |
| EXAMPLES 1 | 4327 | 0.84 | 1.11 | 1.67 | 1382 | 39.5 | 8.10 | 20.5 |
| EXAMPLES 2 | 4278 | 0.83 | 1.11 | 1.65 | 1385 | 40.2 | 8.13 | 20.6 |
| EXAMPLES 3 | 4379 | 0.84 | 1.11 | 1.66 | 1387 | 38.3 | 8.09 | 20.3 |
| EXAMPLES 4 | 4385 | 0.84 | 1.11 | 1.64 | 1391 | 38.9 | 8.10 | 20.5 |
| EXAMPLES 5 | 4345 | 0.83 | 1.10 | 1.63 | 1361 | 39.2 | 8.11 | 20.4 |
| EXAMPLES 6 | 4371 | 0.83 | 1.10 | 1.65 | 1372 | 39.9 | 8.12 | 20.9 |
| EXAMPLES 7 | 4385 | 0.82 | 1.10 | 1.66 | 1385 | 39.5 | 8.10 | 21.1 |
| EXAMPLES 8 | 4295 | 0.83 | 1.11 | 1.63 | 1375 | 40.5 | 8.11 | 21.5 |
| EXAMPLES 9 | 4392 | 0.84 | 1.10 | 1.68 | 1385 | 39.4 | 8.11 | 20.9 |
| EXAMPLES 10 | 4388 | 0.83 | 1.11 | 1.68 | 1392 | 39.7 | 8.14 | 20.8 |
| EXAMPLES 11 | 4312 | 0.83 | 1.12 | 1.67 | 1376 | 39.6 | 8.13 | 20.7 |
| EXAMPLES 12 | 4387 | 0.84 | 1.11 | 1.69 | 1372 | 39.2 | 8.10 | 21.1 |
| EXAMPLES 13 | 4279 | 0.82 | 1.10 | 1.63 | 1357 | 41.0 | 8.15 | 21.0 |
| EXAMPLES 14 | 4366 | 0.83 | 1.12 | 1.65 | 1375 | 39.5 | 8.11 | 21.3 |
| EXAMPLES 15 | 4180 | 0.79 | 1.09 | 1.51 | 1332 | 40.9 | 8.19 | 18.5 |
| EXAMPLES 16 | 4289 | 0.82 | 1.10 | 1.64 | 1355 | 40.1 | 8.14 | 19.8 |
| EXAMPLES 17 | 4323 | 0.83 | 1.10 | 1.63 | 1382 | 39.6 | 8.11 | 20.2 |
| EXAMPLES 18 | 4266 | 0.82 | 1.09 | 1.61 | 1343 | 40.2 | 8.14 | 19.7 |
| EXAMPLES 19 | 4301 | 0.82 | 1.10 | 1.62 | 1345 | 40.2 | 8.13 | 19.4 |
| EXAMPLES 20 | 4188 | 0.81 | 1.08 | 1.58 | 1321 | 38.9 | 8.10 | 18.9 |
| EXAMPLES 21 | 4275 | 0.83 | 1.10 | 1.62 | 1352 | 39.2 | 8.11 | 19.9 |
| EXAMPLES 22 | 4311 | 0.84 | 1.11 | 1.64 | 1361 | 39.6 | 8.11 | 20.4 |
| EXAMPLES 23 | 4270 | 0.82 | 1.11 | 1.62 | 1345 | 40.2 | 8.13 | 19.9 |
| EXAMPLES 24 | 4222 | 0.81 | 1.10 | 1.63 | 1355 | 40.1 | 8.15 | 19.2 |
| EXAMPLES 25 | 4215 | 0.82 | 1.10 | 1.60 | 1345 | 40.6 | 8.15 | 20.2 |
| EXAMPLES 26 | 4311 | 0.84 | 1.11 | 1.65 | 1376 | 39.9 | 8.11 | 20.5 |
| EXAMPLES 27 | 4319 | 0.84 | 1.11 | 1.65 | 1379 | 39.5 | 8.11 | 20.5 |
| EXAMPLES 28 | 4278 | 0.83 | 1.11 | 1.63 | 1368 | 39.8 | 8.12 | 20.4 |
| EXAMPLES 29 | 4234 | 0.82 | 1.10 | 1.61 | 1359 | 40.8 | 8.14 | 20.1 |

### Comparative Examples 1-8

Apart from using an alloy compositions and thickness as shown in Table 2 instead of the composition and film thickness of the WV alloy, which is the second nonmagnetic undercoat layer, the magnetic recording medium was made in the same way as for Example 1.

### Comparative Examples 9-10

Apart from using an alloy of a composition as shown in Table 2 instead of the composition and film thickness of the WV alloy, which is the second configurational layer in the nonmagnetic undercoat layer, and a CoCrTa alloy (Co: 70 at %, Cr: 28 at %, Ta: 2 at %) instead of an RuCr alloy as the nonmagnetic intermediate layer, the magnetic recording medium was made in the same way as for Example 1.

TABLE 2

| | NONMAGNETIC UNDERCOAT LAYER | | | | NONMAGNETIC | |
|---|---|---|---|---|---|---|
| | 1st UNDERCOAT LAYER | | 2nd UNDERCOAT LAYER | | INTERMEDIATE LAYER | |
| | | FILM | | FILM | | FILM |
| | ALLOY | THICKNESS | ALLOY | THICKNESS | ALLOY | THICKNESS |
| | COMPOSITION | (nm) | COMPOSITION | (nm) | COMPOSITION | (nm) |
| COMPARATIVE | Cr | 2 | 80W—20V | 0.5 | 80Ru—20Cr | 4 |
| EXAMPLE 1 | | | | | | |
| COMPARATIVE | Cr | 2 | 80W—20V | 12 | 80Ru—20Cr | 4 |
| EXAMPLE 2 | | | | | | |
| COMPARATIVE | Cr | 2 | 40W—60V | 3 | 80Ru—20Cr | 4 |
| EXAMPLE 3 | | | | | | |
| COMPARATIVE | Cr | 2 | 40Mo—60V | 3 | 80Ru—20Cr | 4 |
| EXAMPLE 4 | | | | | | |
| COMPARATIVE | Cr | 2 | W | 3 | 80Ru—20Cr | 4 |
| EXAMPLE 5 | | | | | | |
| COMPARATIVE | Cr | 2 | Mo | 3 | 80Ru—20Cr | 4 |
| EXAMPLE 6 | | | | | | |
| COMPARATIVE | Cr | 2 | 80Cr—20Mo | 3 | 80Ru—20Cr | 4 |
| EXAMPLE 7 | | | | | | |
| COMPARATIVE | Cr | 2 | 75Cr—20Mo—5B | 3 | 80Ru—20Cr | 4 |
| EXAMPLE 8 | | | | | | |
| COMPARATIVE | Cr | 2 | 80Cr—20Mo | 3 | 70Co—28Cr—2Ta | 2 |
| EXAMPLE 9 | | | | | | |
| COMPARATIVE | Cr | 2 | 75Cr—20Mo—5B | 3 | 70Co—28Cr—2Ta | 2 |
| EXAMPLE 10 | | | | | | |

| | COERCIVE | | | | | | | |
|---|---|---|---|---|---|---|---|---|
| | FORCE | ANGULARITY | | | TAA | OW | PW50 | SNR |
| | (Oe) | RATIO | OR | MrtOR | (μV) | (dB) | (ns) | (dB) |
| COMPARATIVE | 3872 | 0.77 | 1.08 | 1.51 | 1274 | 41.8 | 8.25 | 19.1 |
| EXAMPLE 1 | | | | | | | | |
| COMPARATIVE | 4756 | 0.85 | 1.12 | 1.67 | 1385 | 35.1 | 8.29 | 18.5 |
| EXAMPLE 2 | | | | | | | | |
| COMPARATIVE | 4245 | 0.81 | 1.10 | 1.62 | 1378 | 39.2 | 8.19 | 18.8 |
| EXAMPLE 3 | | | | | | | | |
| COMPARATIVE | 4198 | 0.80 | 1.11 | 1.61 | 1364 | 39.4 | 8.16 | 18.6 |
| EXAMPLE 4 | | | | | | | | |
| COMPARATIVE | 4120 | 0.78 | 1.09 | 1.56 | 1295 | 40.6 | 8.22 | 18.0 |
| EXAMPLE 5 | | | | | | | | |
| COMPARATIVE | 4145 | 0.77 | 1.08 | 1.54 | 1296 | 41.1 | 8.25 | 18.4 |
| EXAMPLE 6 | | | | | | | | |
| COMPARATIVE | 3571 | 0.69 | 1.04 | 1.31 | 1075 | 43.9 | 8.51 | 16.5 |
| EXAMPLE 7 | | | | | | | | |
| COMPARATIVE | 3467 | 0.65 | 1.03 | 1.29 | 1054 | 44.5 | 8.60 | 15.9 |
| EXAMPLE 8 | | | | | | | | |
| COMPARATIVE | 4105 | 0.76 | 1.07 | 1.60 | 1345 | 41.7 | 8.25 | 19.0 |
| EXAMPLE 9 | | | | | | | | |
| COMPARATIVE | 4078 | 0.75 | 1.08 | 1.57 | 1318 | 42.5 | 8.26 | 19.2 |
| EXAMPLE 10 | | | | | | | | |

### Example 30

A nonmagnetic substrate 1 was used, wherein an NiP film (thickness 12 μm) was formed by electroless deposition on the surface of a substrate made of Al (outside diameter 95 mm, inside diameter 25 mm, thickness 1.270 mm), and the surface average roughness Ra was made to be 0.5 nm by performing texture processing on the surface thereof. The nonmagnetic substrate 1 was accommodated in the chamber of a DC magnetron sputter device (Aneruva Corp., C3010), and after the chamber was evacuated to a vacuum attainment level of 2×10⁻⁷ Torr (2.7×10⁻⁵ Pa), the nonmagnetic substrate 1 was heated to 250° C. A nonmagnetic undercoat layer 2 was provided on this substrate. The nonmagnetic undercoat layer 2 was made to have a multilayer structure, with a second configuration layer (thickness 3 nm) comprising a WV alloy (W: 80 at %, V: 20 at %) on a first configuration layer (thickness 2 nm) comprising Cr. Next, a stabilizing layer 7 (thickness 3 nm) comprising a CoCrPtTa alloy (Co: 67 at %, Cr: 20 at %, Pt: 10 at %, Ta: 3 at %) was formed. Next, a non-magnetic coupling layer 8 (thickness 0.8 nm) comprising Ru was formed. Next, a magnetic layer 4 was provided. A first configuration layer (thickness 10 nm) comprising a CoCrPtB alloy (Co: 60 at %, Cr: 25 at %, Pt: 14 at %, B: 6 at %) was formed. Then, on top of this, a second configuration layer (thickness 10 nm) comprising a CoCrPtB alloy (Co: 60 at %, Cr: 10 at %, Pt: 15 at %, B: 15 at %) was formed. When forming each of the above-mentioned layers, Ar was used as the sputter gas, and the pressure thereof was made to be 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 11 was obtained.

### Examples 31-43

Apart from using an alloy of a composition as shown in Table 3 instead of the composition and film thickness of the WV alloy, which is the second nonmagnetic undercoat layer 2, the magnetic recording medium 11 was made as for Example 30.

TABLE 3

| | NONMAGNETIC UNDERCOAT LAYER | | | | | |
|---|---|---|---|---|---|---|
| | 1st UNDERCOAT | | 2nd UNDERCOAT | | | |
| | LAYER | | LAYER | | | |
| | | FILM | | FILM | STABILIZING LAYER | |
| | ALLOY | THICKNESS | ALLOY | THICKNESS | ALLOY | FILM |
| | COMPOSITION | (nm) | COMPOSITION | (nm) | COMPOSITION | THICKNESS (nm) |
| EXAMPLES 30 | Cr | 2 | 80W—20V | 3 | 67Co—20Cr—10Pt—3Ta | 3 |
| EXAMPLES 31 | Cr | 2 | 80W—20V | 2 | 67Co—20Cr—10Pt—3Ta | 3 |
| EXAMPLES 32 | Cr | 2 | 80W—20V | 5 | 67Co—20Cr—10Pt—3Ta | 3 |
| EXAMPLES 33 | Cr | 2 | 90W—10V | 3 | 67Co—20Cr—10Pt—3Ta | 3 |
| EXAMPLES 34 | Cr | 2 | 60W—40V | 3 | 67Co—20Cr—10Pt—3Ta | 3 |
| EXAMPLES 35 | Cr | 2 | 70W—20V—10Al | 3 | 67Co—20Cr—10Pt—3Ta | 3 |
| EXAMPLES 36 | Cr | 2 | 75W—20V—5B | 3 | 67Co—20Cr—10Pt—3Ta | 3 |
| EXAMPLES 37 | Cr | 2 | 65W—20V—10Al—5B | 3 | 67Co—20Cr—10Pt—3Ta | 3 |
| EXAMPLES 38 | Cr | 2 | 80Mo—20V | 3 | 67Co—20Cr—10Pt—3Ta | 3 |
| EXAMPLES 39 | Cr | 2 | 90Mo—10V | 3 | 67Co—20Cr—10Pt—3Ta | 3 |
| EXAMPLES 40 | Cr | 2 | 60Mo—40V | 3 | 67Co—20Cr—10Pt—3Ta | 3 |
| EXAMPLES 41 | Cr | 2 | 70Mo—20V—10Al | 3 | 67Co—20Cr—10Pt—3Ta | 3 |
| EXAMPLES 42 | Cr | 2 | 75Mo—20V—5B | 3 | 67Co—20Cr—10Pt—3Ta | 3 |
| EXAMPLES 43 | Cr | 2 | 65Mo—20V—10Al—5B | 3 | 67Co—20Cr—10Pt—3Ta | 3 |
| COMPARATIVE | Cr | 2 | 80Cr—20Mo | 3 | 67Co—20Cr—10Pt—3Ta | 3 |
| EXAMPLE 11 | | | | | | |
| COMPARATIVE | Cr | 2 | 75Cr—20Mo—5B | 3 | 67Co—20Cr—10Pt—3Ta | 3 |
| EXAMPLE 12 | | | | | | |
| COMPARATIVE | Cr | 2 | 80Cr—20Mo | 3 | 77Co—20Cr—3Ta | 3 |
| EXAMPLE 13 | | | | | | |
| COMPARATIVE | Cr | 2 | 75Cr—20Mo—5B | 3 | 77Co—20Cr—3Ta | 3 |
| EXAMPLE 14 | | | | | | |

| | COERCIVE | | | | | | | |
|---|---|---|---|---|---|---|---|---|
| | FORCE | ANGULARITY | | | TAA | OW | PW50 | SNR |
| | (Oe) | RATIO | OR | MrtOR | (μV) | (dB) | (ns) | (dB) |
| EXAMPLES 30 | 4457 | 0.84 | 1.12 | 1.66 | 1362 | 38.6 | 8.04 | 21.1 |
| EXAMPLES 31 | 4405 | 0.83 | 1.11 | 1.64 | 1355 | 39.2 | 8.07 | 20.9 |
| EXAMPLES 32 | 4512 | 0.84 | 1.12 | 1.67 | 1365 | 37.6 | 8.05 | 20.8 |
| EXAMPLES 33 | 4427 | 0.83 | 1.12 | 1.67 | 1357 | 38.5 | 8.05 | 20.9 |
| EXAMPLES 34 | 4406 | 0.84 | 1.11 | 1.66 | 1361 | 38.1 | 8.05 | 20.8 |
| EXAMPLES 35 | 4451 | 0.83 | 1.10 | 1.64 | 1354 | 39.0 | 8.07 | 21.3 |
| EXAMPLES 36 | 4472 | 0.82 | 1.11 | 1.65 | 1362 | 38.7 | 8.04 | 21.3 |
| EXAMPLES 37 | 4417 | 0.82 | 1.10 | 1.64 | 1352 | 39.6 | 8.05 | 21.7 |
| EXAMPLES 38 | 4454 | 0.83 | 1.11 | 1.64 | 1376 | 38.5 | 8.06 | 20.7 |
| EXAMPLES 39 | 4417 | 0.83 | 1.11 | 1.65 | 1365 | 38.4 | 8.04 | 20.8 |
| EXAMPLES 40 | 4465 | 0.83 | 1.12 | 1.61 | 1357 | 38.9 | 8.03 | 20.9 |
| EXAMPLES 41 | 4417 | 0.84 | 1.10 | 1.63 | 1364 | 38.1 | 8.05 | 21.1 |
| EXAMPLES 42 | 4418 | 0.83 | 1.10 | 1.67 | 1372 | 37.9 | 8.06 | 21.2 |
| EXAMPLES 43 | 4471 | 0.84 | 1.10 | 1.69 | 1381 | 38.7 | 8.05 | 21.3 |
| COMPARATIVE | 3615 | 0.59 | 1.04 | 1.41 | 1157 | 42.5 | 8.65 | 16.3 |
| EXAMPLE 11 | | | | | | | | |
| COMPARATIVE | 3725 | 0.63 | 1.05 | 1.39 | 1146 | 42.7 | 8.71 | 15.9 |
| EXAMPLE 12 | | | | | | | | |
| COMPARATIVE | 4378 | 0.78 | 1.10 | 1.59 | 1315 | 40.5 | 8.21 | 19.3 |
| EXAMPLE 13 | | | | | | | | |
| COMPARATIVE | 4311 | 0.77 | 1.09 | 1.56 | 1305 | 41.1 | 8.25 | 19.5 |
| EXAMPLE 14 | | | | | | | | |

### Comparative Examples 11-12

Apart from using an alloy of a composition as shown in Table 3 instead of the composition and film thickness of the WV alloy, which is the second nonmagnetic undercoat layer, the magnetic recording medium was made in the same way as for Example 30.

### Comparative Examples 13-14

Apart from using an alloy of a composition as shown in Table 3 instead of the composition and film thickness of the WV alloy, which is the second configurational layer in the nonmagnetic undercoat layer, and a CoCrTa alloy (Co: 77 at %, Cr: 20 at %, Ta: 3 at %) instead of a CoCrPtTa alloy as the stabilizing layer, the magnetic recording medium 11 was made in the same way as for Example 30.

### Example 44

A nonmagnetic substrate 1, where texture processing was performed on a glass substrate (outside diameter 65 mm, inside diameter 20 mm, thickness 0.635 mm) to make the surface average roughness Ra 0.3 nm, was used. The nonmagnetic substrate 1 was accommodated in the chamber of a DC magnetron sputter device (Aneruva Corp., C3010), and after the chamber was evacuated to a vacuum attainment level of 2×10⁻⁷ Torr (2.7×10⁻⁵ Pa), the nonmagnetic substrate 1 was heated to 250° C. After an orientation adjustment layer (thickness 5 nm) comprising a CoW alloy (Co: 50 at %, W: 50 at %) was formed on this substrate, this was heated to 250° C.

Next, the surface of the orientation adjustment layer was exposed to oxygen gas. The pressure of the oxygen gas was made to be 0.05 Pa, and the process time was made to be 5 seconds. The nonmagnetic undercoat layer 2 was provided on this substrate. The nonmagnetic undercoat layer 2 was made to have a multilayer structure, with a second configuration layer (thickness 3 nm) comprising a WV alloy (W: 80 at %, V: 20 at %) on a first configuration layer (thickness 2 nm) comprising Cr. Next a nonmagnetic intermediate layer 3 (thickness 4 nm) comprising an RuCr alloy (Ru: 80 at %, Cr: 20 at %) was formed. Next, a magnetic layer 4 was provided. A first configuration layer (thickness 10 nm) comprising a CoCrPtB alloy (Co: 60 at %, Cr: 25 at %, Pt: 14 at %, B: 6 at %) was then formed. Then, on top of this, a second configuration layer (thickness 10 nm) comprising a CoCrPtB alloy (Co: 60 at %, Cr: 10 at %, Pt: 15 at %, B: 15 at %) was formed.

When forming each of the above-mentioned layers, Ar was used as the sputter gas, and the pressure thereof was made to be 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 10 was obtained.

### Examples 45-57

Apart from using an alloy of a composition and film thickness as shown in Table 4 instead of the composition and film thickness of the WV alloy, which is the second configurational layer in the nonmagnetic undercoat layer 2, the magnetic recording medium 10 was made as for Example 44.

TABLE 4

| | NONMAGNETIC UNDERCOAT LAYER | | | | NONMAGNETIC | |
|---|---|---|---|---|---|---|
| | 1st UNDERCOAT | | 2nd UNDERCOAT | | INTERMEDIATE | |
| | LAYER | | LAYER | | LAYER | |
| | | FILM | | FILM | | FILM |
| | ALLOY | THICKNESS | ALLOY | THICKNESS | ALLOY | THICKNESS |
| | COMPOSITION | (nm) | COMPOSITION | (nm) | COMPOSITION | (nm) |
| EXAMPLES 44 | Cr | 2 | 80W—20V | 3 | 80Ru—20Cr | 4 |
| EXAMPLES 45 | Cr | 2 | 80W—20V | 2 | 80Ru—20Cr | 4 |
| EXAMPLES 46 | Cr | 2 | 80W—20V | 5 | 80Ru—20Cr | 4 |
| EXAMPLES 47 | Cr | 2 | 90W—10V | 3 | 80Ru—20Cr | 4 |
| EXAMPLES 48 | Cr | 2 | 60W—40V | 3 | 80Ru—20Cr | 4 |
| EXAMPLES 49 | Cr | 2 | 70W—20V—10Al | 3 | 80Ru—20Cr | 4 |
| EXAMPLES 50 | Cr | 2 | 75W—20V—5B | 3 | 80Ru—20Cr | 4 |
| EXAMPLES 51 | Cr | 2 | 65W—20V—10Al—5B | 3 | 80Ru—20Cr | 4 |
| EXAMPLES 52 | Cr | 2 | 80Mo—20V | 3 | 80Ru—20Cr | 4 |
| EXAMPLES 53 | Cr | 2 | 90Mo—10V | 3 | 80Ru—20Cr | 4 |
| EXAMPLES 54 | Cr | 2 | 60Mo—40V | 3 | 80Ru—20Cr | 4 |
| EXAMPLES 55 | Cr | 2 | 70Mo—20V—10Al | 3 | 80Ru—20Cr | 4 |
| EXAMPLES 56 | Cr | 2 | 75Mo—20V—5B | 3 | 80Ru—20Cr | 4 |
| EXAMPLES 57 | Cr | 2 | 65Mo—20V—10Al—5B | 3 | 80Ru—20Cr | 4 |
| COMPARATIVE | Cr | 2 | 80Cr—20Mo | 3 | 80Ru—20Cr | 4 |
| EXAMPLE 15 | | | | | | |
| COMPARATIVE | Cr | 2 | 75Cr—20Mo—5B | 3 | 80Ru—20Cr | 4 |
| EXAMPLE 16 | | | | | | |
| COMPARATIVE | Cr | 2 | 80Cr—20Mo | 3 | 70Co—28Cr—2Ta | 2 |
| EXAMPLE 17 | | | | | | |
| COMPARATIVE | Cr | 2 | 75Cr—20Mo—5B | 3 | 70Co—28Cr—2Ta | 2 |
| EXAMPLE 18 | | | | | | |

| | COERCIVE | | | | | | | |
|---|---|---|---|---|---|---|---|---|
| | FORCE | ANGULARITY | | | TAA | OW | PW50 | SNR |
| | (Oe) | RATIO | OR | MrtOR | (μV) | (dB) | (ns) | (dB) |
| EXAMPLES 44 | 4217 | 0.79 | 1.07 | 1.45 | 1265 | 41.3 | 8.25 | 19.1 |
| EXAMPLES 45 | 4192 | 0.78 | 1.06 | 1.42 | 1241 | 41.8 | 8.26 | 19.0 |
| EXAMPLES 46 | 4275 | 0.79 | 1.07 | 1.46 | 1261 | 40.7 | 8.26 | 18.8 |
| EXAMPLES 47 | 4239 | 0.79 | 1.07 | 1.45 | 1263 | 40.6 | 8.24 | 19.0 |
| EXAMPLES 48 | 4215 | 0.78 | 1.06 | 1.42 | 1242 | 41.2 | 8.27 | 18.8 |
| EXAMPLES 49 | 4229 | 0.78 | 1.07 | 1.44 | 1255 | 40.9 | 8.24 | 19.4 |
| EXAMPLES 50 | 4217 | 0.77 | 1.06 | 1.43 | 1241 | 41.2 | 8.25 | 19.6 |
| EXAMPLES 51 | 4219 | 0.78 | 1.07 | 1.46 | 1261 | 40.7 | 8.25 | 19.8 |
| EXAMPLES 52 | 4218 | 0.78 | 1.07 | 1.44 | 1257 | 41.1 | 8.26 | 19.1 |
| EXAMPLES 53 | 4241 | 0.78 | 1.07 | 1.45 | 1261 | 41.2 | 8.26 | 19.0 |
| EXAMPLES 54 | 4211 | 0.78 | 1.06 | 1.46 | 1271 | 40.8 | 8.26 | 19.0 |
| EXAMPLES 55 | 4217 | 0.78 | 1.07 | 1.44 | 1263 | 41.4 | 8.25 | 19.2 |
| EXAMPLES 56 | 4198 | 0.77 | 1.07 | 1.45 | 1245 | 41.6 | 8.25 | 19.4 |
| EXAMPLES 57 | 4217 | 0.78 | 1.07 | 1.46 | 1271 | 40.4 | 8.24 | 19.6 |
| COMPARATIVE | 3175 | 0.57 | 1.02 | 1.21 | 1041 | 44.3 | 8.69 | 15.3 |
| EXAMPLE 15 | | | | | | | | |
| COMPARATIVE | 3052 | 0.55 | 1.02 | 1.23 | 1011 | 44.9 | 8.75 | 15.4 |
| EXAMPLE 16 | | | | | | | | |
| COMPARATIVE | 4105 | 0.76 | 1.05 | 1.37 | 1215 | 42.5 | 8.41 | 18.0 |
| EXAMPLE 17 | | | | | | | | |
| COMPARATIVE | 4121 | 0.75 | 1.04 | 1.36 | 1208 | 42.8 | 8.42 | 18.2 |
| EXAMPLE 18 | | | | | | | | |

### Comparative Examples 15-16

Apart from using an alloy of a composition and film thickness as shown in Table 4 instead of the composition and film thickness of the WV alloy, which is the second nonmagnetic undercoat layer, the magnetic recording medium was made as for Example 44.

### Comparative Examples 17-18

Apart from using an alloy of a composition as shown in Table 4 instead of the composition and film thickness of the WV alloy, which is the second configurational layer in the nonmagnetic undercoat layer, and a CoCrTa alloy (Co: 70 at %, Cr: 28 at %, Ta: 2 at %) instead of an RuCr alloy as the nonmagnetic intermediate layer, the magnetic recording medium was made as for Example 29. The results of coercive force (Hc), rectangularity ratio, magnetization orientation layer (OR), magnetization orientation layer (MrtOR) of the residual magnetization amount, and the electromagnetic transfer characteristics, of Embodiments 1 to 57 and Comparative Examples 1 to 18, are shown in Table 1 to Table 4.

It can be seen from Examples 1 to 29 and the comparisons with the comparative examples, that the WV alloys, the WVAl alloys, the WVB alloys, the WVAlB alloys, the MoV alloys, the MoVAl alloys, the MoVB alloys, and the MoVAlB alloys show superior characteristics. In areas where the WV alloy film thickness is thin, a sufficient coercive force is not obtained, and the characteristics deteriorate as in Comparative Example 1. It can be seen that in areas where the WV alloy film thickness is thick, a coercive force greater than the examples is obtained, but the grain size is increased, decreasing the SNR as in Comparative Example 2. It can be seen that in areas where the V content exceeds 50%, a coercive force equal to the examples is obtained, but the grain size is increased, decreasing the SNR as in Comparative Examples 3 and 4. It can be seen that in a case where single metals of W and Mo are used, a coercive force and a square shape is not obtained, and the SNR deteriorates as in Comparative Examples 5 and 6. Comparative Examples 7 and 8 are cases where CrMo alloys and CrMoB alloys, which are generally used in magnetic recording mediums, have been used. However the lattice constants of CrMo alloys and CrMoB alloys are small compared to the WV alloy and MoV alloy, and hence the RuCr alloy does not sufficiently epitaxially grow in the (110) direction. Therefore, as a result, the characteristics are considerably deteriorated. In a case where a CrMo alloy and CrMoB alloy is used, as shown in Comparative Examples 9 and 10, a CoCrTa alloy is generally used. However, even in this case, it can be seen that compared to the examples, the SNR is inferior.

Examples 30 to 43 are cases where WV alloys, WVAl alloys, WVB alloys, WVAlB alloys, MoV alloys, MoVAl alloys, MoVB alloys, and MoVAlB alloys have been applied to ACF mediums. It can be seen that in all cases, they are superior to the comparative examples. Comparative Examples 11 and 12 are cases where CrMo alloys and CrMoB alloys, which are generally used in magnetic recording mediums, have been used. However the lattice constants of CrMo alloys and CrMoB alloys are small compared to the WV alloy and MoV alloy, and hence the CoCrPtTa alloy does not sufficiently epitaxially grow in the (110) direction. Therefore, as a result, the characteristics are considerably deteriorated. In a case where a CrMo alloy and CrMoB alloy is used, as shown in Comparative Examples 13 and 14, a CoCrTa alloy is generally used. However, even in this case, it can be seen that compared to the examples, the SNR is inferior.

Examples 44 to 57 are cases where WV alloys, WVAl alloys, WVB alloys, WVAlB alloys, MoV alloys, MoVAl alloys, MoVB alloys, and MoVAlB alloys have been applied to mediums which use a glass substrate for the nonmagnetic substrate. It can be seen that in all cases, they are superior to the comparative examples. Comparative Examples 15 and 16 are cases where CrMo alloys and CrMoB alloys, which are generally used in magnetic recording mediums, have been used. However the lattice constants of CrMo alloys and CrMoB alloys are small compared to the WV alloy and MoV alloy, and hence the RuCr alloy does not sufficiently epitaxially grow in the (110) direction. Therefore, as a result, the characteristics are considerably deteriorated. In a case where a CrMo alloy and CrMoB alloy is used, as shown in Comparative Examples 17 and 18, a CoCrTa alloy is generally used. However, even in this case, it can be seen that compared to the examples, the SNR is inferior.

### INDUSTRIAL APPLICABILITY

The magnetic recording medium of the present invention comprises at least a nonmagnetic undercoat layer, a nonmagnetic intermediate layer or a stabilizing layer, and a magnetic layer, and a protective layer, which are laminated in this order on a nonmagnetic substrate. Provision of at least one of the layers of the nonmagnetic undercoat layer by a WV type alloy or a MoV type alloy makes it possible to reduce noise, which results in obtaining the magnetic recording medium suitable for high recording density.

1. A magnetic recording medium comprising at least a nonmagnetic undercoat layer, a nonmagnetic intermediate layer, a magnetic layer, and a protective layer, which are laminated in ascending order on a nonmagnetic substrate,
wherein at least one layer of said nonmagnetic undercoat layer is formed by a WV alloy or a MoV alloy.

2. A magnetic recording medium comprising at least a nonmagnetic undercoat layer, a stabilizing layer, a nonmagnetic intermediate layer, a magnetic layer, and a protective layer laminated in ascending order on a nonmagnetic substrate,
wherein said stabilizing layer is antiferromagnetically bonded to said magnetic layer, and at least one layer of said nonmagnetic undercoat layer is formed by a WV alloy or a MoV alloy.

3. A magnetic recording medium according to either one of claim 1 and claim 2, wherein the WV alloy utilized in said nonmagnetic undercoat layer has a W content of 50 to 99 at %, and a V content of 1 to 50 at %.

4. A magnetic recording medium according to either one of claim 1 and claim 2, wherein the MoV alloy utilized in said nonmagnetic undercoat layer has a Mo content of 50 to 99 at %, and a V content of 1 to 50 at %.

5. A magnetic recording medium according to either one of claim 1 and claim 2, wherein said nonmagnetic intermediate layer comprises at least one type selected from the group consisting of a CoCr alloy, a CoCrPt alloy, Ru, a Ru alloy, Re, and a Re alloy.

6. A magnetic recording medium according to either one of claim 1 and claim 2, wherein said non-magnetic coupling layer comprises at least one type elected from the group consisting of Ru, Rh, Ir, Cr, Re, Ru alloy, Rh alloy, Ir alloy, Cr alloy, and Re alloy, and said non-magnetic coupling layer has a thickness of 0.5 to 1.5 nm.

7. A magnetic recording medium according to either one of claim 1 and claim 2, wherein said nonmagnetic intermediate layer is formed by at least one alloy selected from the group consisting of a CoCrZr alloy, a CoCrTa alloy, a CoRu alloy, a CoCrRu alloy, a CoCrPtZr alloy, a CoCrPtTa alloy, a CoPtRu alloy, and a CoCrPtRu alloy.

8. A magnetic recording medium according to either one of claim 1 and claim 2, wherein said nonmagnetic undercoat layer has a multilayer structure containing a layer made of Cr or a Cr alloy containing Cr and at least one type selected from the group consisting of Ti, Mo, Al, Ta, W, Ni, B, Si, Mn and V, and a layer made of a WV alloy or a MoV alloy.

9. A magnetic recording medium according to either one of claim 1 and claim 2, wherein said magnetic layer is made of at least one alloy selected from the group consisting of a CoCrTa alloy, a CoCrPtTa alloy, a CoCrPtB alloy, and a CoCrPtBM (where M is one or more elements selected from Ta, Cu, and Ag) alloy.

10. A magnetic recording medium according to either one of claim 1 and claim 2, wherein said nonmagnetic substrate is a glass substrate or a silicon substrate.

11. A magnetic recording medium according to either one of claim 1 and claim 2, wherein said nonmagnetic substrate is one where a film comprising NiP or a NiP alloy has been formed on the surface of a substrate made of one type selected from the group consisting of Al, Al alloy, glass, and silicon.

12. A method of producing a magnetic recording medium having at least a nonmagnetic undercoat layer, a nonmagnetic intermediate layer, a magnetic layer, and a protective layer laminated in this order on a nonmagnetic substrate, wherein at least one layer of said nonmagnetic undercoat layer is formed by a WV alloy or a MoV alloy.

13. A method of producing a magnetic recording medium having at least a nonmagnetic undercoat layer, a stabilizing layer, a non-magnetic coupling layer, a magnetic layer, and a protective layer laminated in this order on a nonmagnetic substrate, where said stabilizing layer is antiferromagnetically bonded to the magnetic layer, wherein at least one layer of said nonmagnetic undercoat layer is configured by a WV alloy or a MoV alloy.

14. A magnetic recording and reproducing apparatus characterized in comprising a magnetic recording medium according to either one of claim 1 and claim 2, and a magnetic head which records and reproduces information on said magnetic recording medium.
